(19) United States
(12) Patent Application Publication
(10) Pub. No.: US 2018/0253967 A1
(43) Pub. Date: Sep. 6, 2018

(54) Traffic Signal Real Time Moding Control Method

(71) Applicant: Weiping Meng, Flushing, NY (US)

(72) Inventor: Weiping Meng, Flushing, NY (US)

(21) Appl. No.: 15/908,753

(22) Filed: Feb. 28, 2018

(30) Foreign Application Priority Data
Mar. 1, 2017 (CN) 201710116209.8

(51) Int. Cl. G08G 1/087; G08G 1/01; G08G 1/052

(52) U.S. Cl. CPC G08G 1/087; G08G 1/052; G08G 1/0104

(57) ABSTRACT

The invention relates to a traffic signal mode field, discloses a method that supports the mode-changing of traffic signals in real time, acts including: 1) recognize a mode instruction, 2) calculate and configure the interim period according to the mode instruction, 3) run the instructed mode after the interim period runs out. The present invention optimizes signal mode conversion, shorten the time of signal mode conversion, obtain 0 redundent waiting mode conversion and smoothly switching, lessen the response time of signals with traffic change, solving the beset “A mode response for smooth traffic may turn out to be an aggravating congestion factor.”, improving the real time performance of traffic signal system. Even if the remainder as wait is compared with for mode switching, this invention also improves the signal efficiency 50%, lessens redundant wait by 50%, makes the smooth conversion of signal modes, avoids traffic jam due to mode changing execellently.

### CROSS REFERENCE TO RELATED APPLICATIONS

(Not Applicable)

### FEDERALLY SPONSORED RESEARCH/DEVELOPMENT

(Not Applicable)

### BACKGROUND OF THE INVENTION

### Technical Field and Prior Art

The present invention generally relates to a method for traffic control, particularly to traffic signal network control method for changing a traffic signal mode into another mode real time.

Currently the most common traffic control method for road network are: RATIO and GREENWAVE. Recently the method for 2 cross-directions greenwave Lead mode, the method for traffic jam relief mode, the method for 2 cross-directions greenwave Jam-Relief mode, and the method for Lead and Jam-Relief mixed mode have been proposed. All of these modes are designed in the different distributions of greenwave time-offsets among the intersections of a roadnet based on its initially mode RATIO. The change among these modes needs first to finish these time-offsets and clean every intersection, the bigger the span of the control area, the longer the time for cleaning intersection, thus the longer the waiting, 1 minute of Red light can bring a hundred or so of vehicles entering the control area and these retenting traffic flow become the cause of congestion, which reduces the effectiveness of the original new modes, brings a beset: “A mode response for smooth traffic may turn out to be an aggravating congestion factor.” Therefore, Realizing the smooth response of mode with reducing the changing time and redundant waiting is significant.

### BRIEF SUMMARY OF THE INVENTION

It is an object of the present invention to reduce the response time of mode changing and its waiting, improve the efficiency of traffic and signal control, through new designed signal algorithm, computer technology, internet, etc, intelligentized means.

The specific contents of the present invention is as follow:

A method for real time changing mode used in road traffic signal network includes steps:

S1: Set RATIO as initial state with obtaining the length and its traffic-time of every road-segment of a roadnet;

S2 set new mode and its interim time-offsets based on a new mode instruction: 1) determine the interim category according to a mode-instruction and the current running mode: wave-initial, wave-delete, or wave-wave, said wave-initial is a mode instruction that orders an intersection to change from a RATIO mode to a greenwave mode, said wave-delete is a mode instruction that orders an intersection to change from current greenwave mode back to RATIO mode, said wave-wave is a mode instruction that orders an intersection to change from current greenwave mode to another greenwave mode; 2) calculate interim-period according to the category: (2.1) find the source-intersections and their positons of the two modes; (2.2) calculate the time-offsets and their period remainder of the new mode of every intersection: said period remainder=remainder of the time-offset/period; (2.3) configure the interim-period corresponding to the period remainder: interim-period=period remainder=master direction interim+slave direction interim;

S3 run the new mode after running out the interim-period of every intersection with red-light-on or without signals;

Another feature of the present invention is that step S1 includes steps of:

S11 Said traffic-time includes set-drive-time or JVQ-start-time: set-drive-time equals to time that a vehicle drives at set-drive-speed through a whole road-segment, JVQ-start-time equals to JVQ-start-coefficient*jam-coefficient*road-segment-length, where the jam-coefficient is less than or equal to one, “equals to one” means that heavy jam occurs;

Another feature of the present invention is that step S1 includes steps of:

S12 Said jammed vehicle-queue-length minus the length of the queue's upstream intersection without any vehicle multiplied by a value less than or equal to one;

Another feature of the present invention is that step S1 includes steps of:

S13 Said jammed vehicle queue-length plus the length of the traffic upstream intersection fully occupied with vehicles;

Another feature of the present invention is that step S1 includes steps of:

S14 Said set-drive-time minus the brake-time of set-drive-speed;

Another feature of the present invention is that the 2) of step S2 includes steps of:

S21 when an interim category is wave-initial, configure wi-interim-period: calculate and configure the greenwave time-offset of every intersection and its interim-period: (S21.1) according to the running rules of the two modes determine the positions of their source-intersections, for a raw RATIO, the source-intersection can be any intersection in a roadnet due to the synchronization of all the intersections, for a greenwave mode, the source-intersection can be determined by the greenwave mode, the source-intersection of a Lead greenwave mode is the first intersection in its channel led traffic direction, the source-intersection of a Jam-Relief greenwave mode is the last intersection in its relieved channel traffic direction, a Lead greenwave direction is same as its channel led traffic direction, but a Jam-Relief greenwave direction is reverse of its channel relieved traffic direction; the 2D modes includes IDEN-Lead, IDEN-Jam-Relief, DIFF-Mix, their origin source-intersections all are at a corner in an area, called as corner-intersection, for a IDEN-Lead mode, the origin intersection is the first intersection both of a direction Lead greenwave and of its cross direction Lead greenwave, for a IDEN-Jam-Relief mode, the origin intersection is the last intersection both of a direction Jam-Relief greenwave and of its cross direction Jam-Relief greenwave, for a DIFF-Mix mode, the origin intersection is the first intersection of a direction led traffic channel with Lead greenwave but the last intersection of its cross direction relieved traffic channel with Jam-Relief greenwave, set one of the two directions as master direction and the other as slave, the source-intersection of the greenwave time-offsets of slave direction channel is the corner-intersection which is one of the source-intersections of master direction greenwave channels; (S21.2) according to the running rules of the two modes determine their time-offsets of every intersection: the sum of the traffic-time from the corner-intersection to one of its downstream intersections for each mode, then get their respective remainder by dividing the sum by the period; (S21.3) configure the wi-interim-period: make a signal interim-period with the remainder, i.e., wi-interim-period;

Another feature of the present invention is that the 2) of step S2 includes steps of:

S22 when an interim category is wave-delete, configure wd-interim-period: calculate and configure the period-complement of every intersection and its wd-interim-period: (S22.1) according to the running rules of the two modes determine the positions of their source-intersections; (S22.2) calculate the remainder and its period-complement of the greenwave time-offset of every intersection of the present mode: period−remainder; (S22.3) configure wd-interim-period: make a signal interim period with the complement for each intersection;

Another feature of the present invention is that the 2) of step S2 includes steps of:

S23 when an interim category is wave-wave, configure ww-interim-period: calculate and configure the switch-time-offset of every intersection and its ww-interim-period: (S23.1) according to the running rules of the two greenwave modes determine the positions of their source-intersections; (S23.2) according to the running rules of the two greenwave modes calculate the greenwave time-offsets, its remainder, and its period-complement of the two modes for every intersection: (1) calculate the remainder and its period-complement of the greenwave time-offset of every intersection of present mode, period-complement=period−remainder, (2) according to the running rules of new greenwave mode calculate the greenwave time-offset and its remainder of every intersection of new mode, (3) calculate the switch-time-offset and its remainder of every intersection: the new mode remainder plus the present mode period-complement is switch-time-offset, divided by period, and get its switch-remainder; (S23.3) configure ww-interim-period: make a signal interim period with the switch-remainder for each intersection;

Another feature of the present invention is that the configure interim-period of step S2 includes steps of:

S24 configure interim-period, according to a mode instruction for an intersection make its signal interim-period before the new mode start to run or during the second half period of the present mode period, for shorter time-offset, make red or green light time longer corresponding to the shorter time-offset, for time-offset shorter than a period, make red and green light interim-period long corresponding to the time-offset;

Another feature of the present invention is that the 2) of step S2 includes steps of:

S25 calculate the greenwave time-offset of new mode of an intersection, when the master direction of new mode is different from the one of present mode, the source-intersection of master direction increases the half of period, or increase the half period of the master direction of present mode, for an example, the ratio is 6/4, its half period of period 90 secs is 54 secs;

Note1: Said an intersection is a cross of multiple road-segments, controlled by corresponding traffic signals network, 1) a road-segment means a connection section between two adjacent intersections. 2) a channel means multi tandem-connected road-segments, a channel from one side of a roadnet to the other side without intersection-turn is a straight channel, denoted by D-channel;

Note2: Said features of roadnet includes the amount of intersections controlled, the distribution of the intersections, the length and the traffic-times of road-segments; said traffic-time includes JVQ-start-time and set-drive-time, a JVQ start-time means time from when the first vehicle of a waiting-queue moves to when the last vehicle of the waiting queue starts to move, said set-driving-time means time that vehicle drives at set-drive-speed from one end of a road-segment to the other end; a roadnet with M*N intersections, denoted by {M,N} or {(0,0),(M−1,N−1)}, which (,) represents the intersection coordinates, M columns of D-channel, or said M col-D-channels, N rows of D-channel, or said N row-D-channels; the set of the values of column-road-segments denoted Col. {M, N-1} {==}, represents the total number M values of columns of D-channels, each col-D-channel including N−1 road-segments, the m-th col-D-channel with the set of the traffic-times of every road-segments of the col-D-channel denoted as col.m{==}, “==” representative for the corresponding values of road-segments of (N−1) columns; the set of the values of row-road-segments denoted Row {N, M−1} {==}, represents the total number N of rows of D-channels, each row-D-channel including M−1 road-segments, the n-th row-D-channel with the set of the traffic-times of every road-segments of the row-D-channel denoted as row n{==}, “==” representative for the corresponding values of road-segments of (M−1) rows; the total number of road-segments at least N*(M−1)+M*(N−1); the values of these set including length, JVQ-start-time, or set-drive-time, their fixed, etc; not a must for absolute parallelism of road-segments.

Note3: Said the greenwave time-offset of intersection in a direction channel is the sum of road-segments' traffic-times from their source-intersection to one of the downstream intersections in the channel; if the mode is Jam-Relief, the traffic-time uses JVQ-start-time, and its source-intersection is the last intersection in the jammed traffic flow direction, if the mode is Lead, the traffic-time uses set-drive-time, and its source-intersection is the first intersection in the led traffic flow direction, the set of features' values are denoted by d#{*}, which are from said Col. {M,N−1} {==} or Row{N,M−1} {==} inserted with traffic-time=0 of column or row for their source-intersection, “d” represents the direction of greenwave, E/East, S/South, W/West, or N/North, etc, “#” represents the coordinates of an intersection, that's, d#{*}=>d(i,j){*}, where this d and the position of the 0 in the set indicate the mode and the greenwave direction of Lead or Jam-Relief, for an example, N(6,2){==,0} represents intersection (6,2), the most North intersection, of North jammed traffic flow in the channel of a roadnet as a source-intersection of Jam-Relief mode and their set of the sum of the JVQ-start-time of the road-segments of the channel, if the 0 is at the left side of the data, i.e., N(6,2){0,==} represents intersection (6,2), the most South intersection, of North led traffic flow in the channel of a roadnet as a source-intersection of Lead mode and their set of the sum of the set-drive-time of the road-segments of the channel; for D-channels, alternatively, the # is a number of a D-channel rather than the coordinates of an edge-intersection, for an example, W1{0,==} represents all the intersection with j=1 of West jammed traffic flow in the channel of a roadnet and their set of the sum of the JVQ-start-time of the road-segments of the channel, the most West intersection is its source-intersection with the greenwave time-offset 0 of Jam-Relief mode, while S4{0,==} represents all the intersection with i=4 of South jammed traffic flow in the channel of a roadnet and their set of the sum of the JVQ-start-time of the road-segments of the channel, the most South intersection is its source-intersection with the greenwave time-offset 0 of Jam-Relief mode, while if W1{==,0}, then it represents all the intersection with j=1 of West led traffic flow in the channel of a roadnet and their set of the sum of the set-drive-time of the road-segments of the channel, the most East intersection is its source-intersection with greenwave time-offset 0 of Lead mode, S4{==,0} represents all the intersection with i=4 of South led traffic flow in the channel of a roadnet and their set of the sum of the set-drive-time of the road-segments of the channel, the most North intersection is its source-intersection with greenwave time-offset 0 of Lead mode;

The advantages of the present invention are below: optimize signal mode conversion, obtain 0 redundent waiting mode conversion, enhance the real time performance of system signals, lessen the response time of signals with traffic change, improving the efficiency of traffic control. Even if the remainder as wait is compared with for mode switching, this invention also improves the signal efficiency 50%, lessens redundant wait by 50%, makes the smooth conversion of signal modes, avoids traffic jam due to mode changing execellently.

### BRIEF DESCRIPTION OF THE DRAWINGS

FIG. 1 is a roadnet with a DIFF-mix mode switching to IDEN-Lead mode;

FIG. 2 is a structure of a roadnet with traffic signal control system and the time-offsets distribution of DIFF-mix mode and IDEN-Lead mode;

FIG. 3 shows the signal distribution of DIFF-mix mode wave-initial: 0->60 seconds;

FIG. 4 shows the signal distribution of DIFF-mix mode wave-delete: 360->420 seconds;

FIG. 5 shows the signal distribution of DIFF-mix mode wave-wave: 360->495 seconds;

FIG. 6 is a flowchart of real time moding control method;

### LIST OF REFERENCE NUMERAL UTILIZED IN THE DRAWING

FIG. 1: 1—roadnet, 2—intersection, 3—North 7 D-channel Lead mode, 4—East 5 Jammed/West Jam-Relief mode, 5—North Led Traffic D-Channels, 6—East Jammed Traffic D-Channels, 7—North Led Traffic D-Channels, 8—East Lead mode;

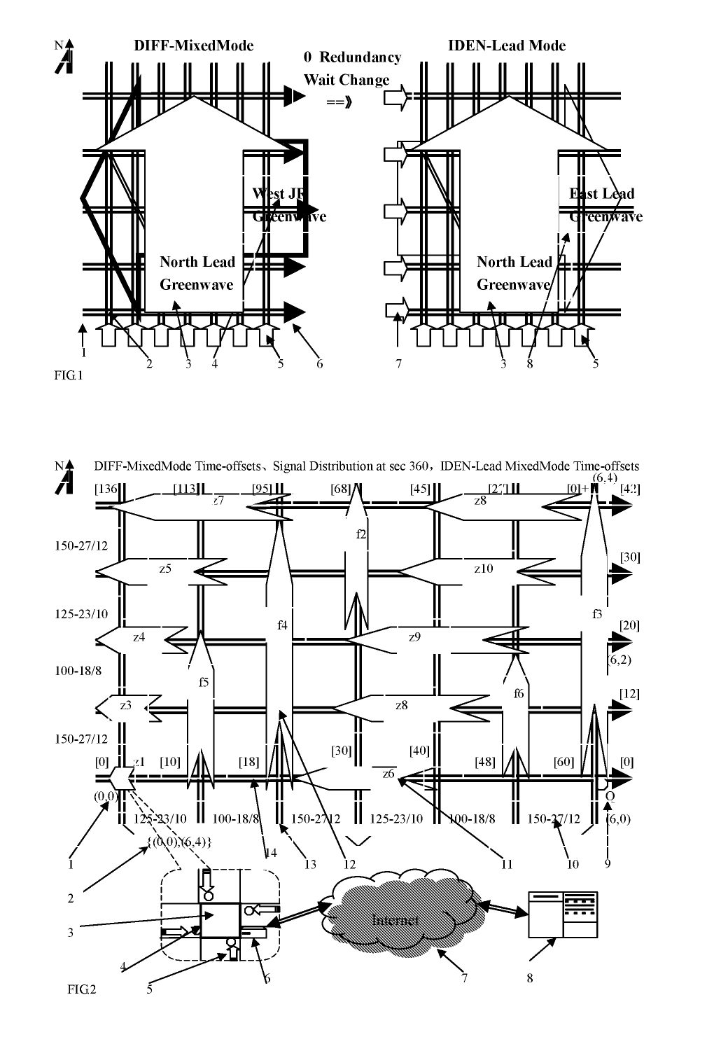

FIG. 2: 1—at the lower-left corner, the origin intersection coordinates (0,0) of a roadnet; 2—roadnet mark {(0,0),(6,4)}; 3—intersection; 4—traffic signals; 5—vehicle queue; 6—traffic signals controller; 7—internet; 8—control system center; 9—the origin of DIFF-mix mode marked as Q and small octagon and its coordinates (6,0); 10—“#−#/#” is for three values: distance between two adjacent intersections−JVQ-start-time/set-drive-time, unit: meter−second/second; 11—master greenwave direction signed with solid line arrow pointing at the left/west, numbered 6, denoted by z6; 12—slave greenwave direction signed with dotted line arrow pointing at the up/north, numbered 4, denoted by f4; the z1 at the lower left corner shows a leaving master greenwave numbered 1; and, the length of the line arrow of the greenwave signs represents an estimate of greenwave time, such as the length of f6 representing about 18 seconds, f4 about 43 sec, z10 about 45 sec; 13—led North flow traffic channels; 14—Relieved East flow jammed traffic channels; the FIG shows the greenwave distribution at the 270^{th} second; the number in square brackets is the greenwave time-offset, listed in the horizontal rows at the top and vertical columns at the right arranged for corresponding intersections of master/slave greenwave channels; hereinafter, the solid line hollow arrow is greenwave and its direction, master direction is West, slave direction is North, the number in square brackets at the upper left of every intersection in channel 1 is the greenwave time-offset of the intersection of new mode IDEN-Lead.

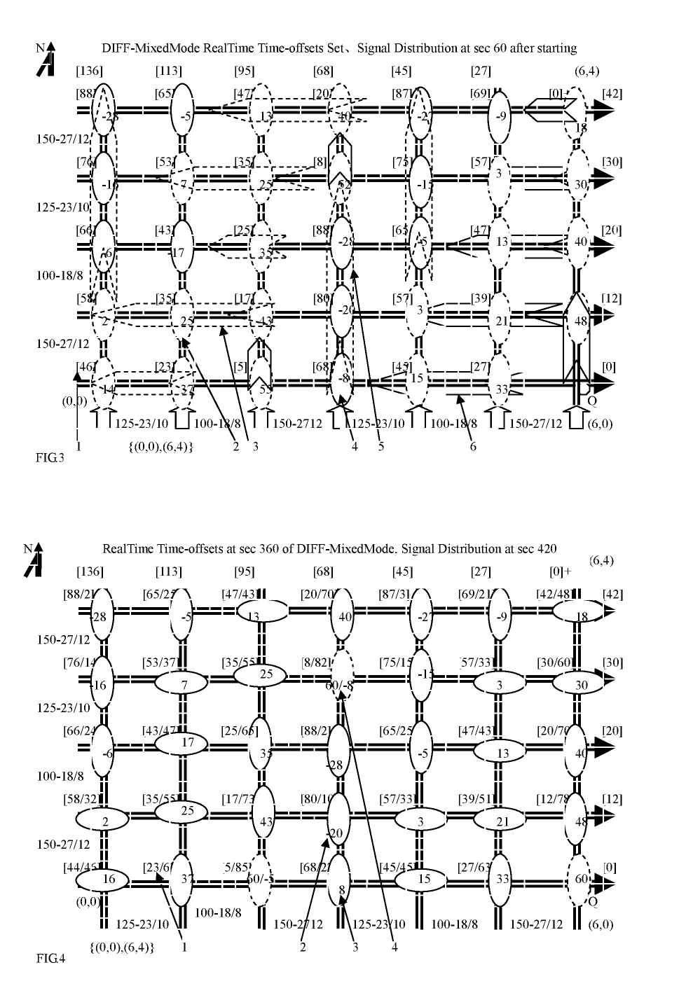

FIG. 3: 1—the number# in square brackets at the upper left of an intersection is for its period remainder, 2—an oval on an intersection is for its running wi-interim-period, a horizontal oval is for its first half interim-period of East/West green lights, vertical oval for its second half of South/North green lights, a dotted oval is for its finished interim-period inwhere the number # is for its having run the greenwave for time#, e.g., the #25 in intersection(1,1) means that the intersection has run new West direction greenwave for 25 seconds, the 25 is local signal time at that time<=time-switched 60−wi-interim-period 35, 3—hollow dotted line arrow is for a pre-greenwave after wi-interim-period runs out, which occurs before the front end of the first greenwave as label 6, 4—a solid line oval and the −# in it means there still is # seconds to run for finishing the wi-interim-period, e.g., −8 here means after 8 seconds the intersection can start its first west direction greenwave period, 5—hollow dotted line arrow here is for a pre-greenwave before wi-interim-period runs out, which and the pre-greenwave as label 3 together are called as quazi-greenwave or derived greenwave, 6—hollow solid line arrow here is for the first wave of the first greenwave;

FIG. 4: 1—the two numbers #/# in square brackets are for the period remainder and period-complement of the intersection at their lower right, 2—an oval on an intersection is for running signals, horizontal oval is for East-West green lights, vertical oval is for South-North green lights, inwhere the number # is for signal time# of the intersection, e.g., the signal time#=time-switched 60−rest time 80 of the greenwave there =−20, the negative number means there still is 20 seconds to run for finishing the current greenwave in order to run the wi-interim-period and recover mode RATIO, 3—signal time # bigger than 0 means that the wd-interim-period has run for the time#, 4—signal time # bigger than wd-interim-period means that the intersection has run for the time# of RATIO mode, wherein /negative value −8 means that the value had been decreased from the last half period of the greenwave, dotted line ovals mean that the wd-interim-period of the intersection has run out; the FIG. shows that the signals distribution at the 420^{th} second when the DIFF-mix mode which had run for 360 seconds, then been instructed to recover mode RATIO, and the wd-interim-period has run for 60 seconds, the origin intersection(6,0) has no time-offset, need no wd-interim-period, has run original period 60 seconds, the signals of other intersections as follows: Intersection(5,0) of East 1 channel, its wd-interim-period=period-complement 63 seconds, at the 420^{th} second, has run for 27 seconds of the second half period of its greenwave and for 33 seconds of its wd-interim-period 63 seconds, where the 33 seconds include the first half wd-interim-period 32 seconds East-West green lights and then the 1 second of the second half wd-interim-period South-North green lights as labeled vertical oval, the recovery time needed=wd-interim-period 63−finished time 33=63−(time switched 60−the rest time 27 of the greenwave)=30 seconds, after the 63 seconds run out, is just in synchronization with the origin intersection; intersection(3,1), its wd-interim-period 10 seconds, at the 420^{th} second, has run for 60 seconds and has 20 seconds to finish its greenwave, i.e., −20, 20 seconds to start its wd-interim-period of 10 seconds, the recovery time needed=wd-interim-period 10−finished time −20=10−(time switched 60−the rest time 80 of the greenwave)=30 seconds, by then just in synchronization with the origin intersection and its direction; intersection(2,0), its wd-interim-period 85, directly decreases the period-remainder 5 from the period, by then just in synchronization with the origin intersection and its direction as labeled vertical dotted line oval, at the 420^{th} second, has run for 60 seconds of the origin period;

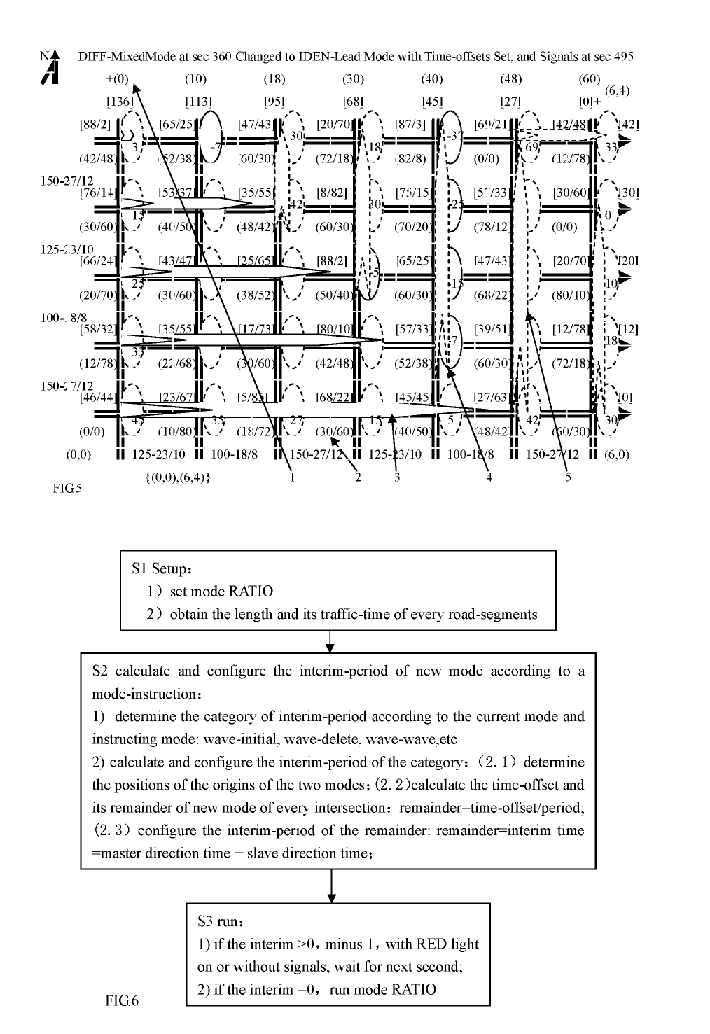

FIG. 5: 1—the number # in parenthesis is for the greenwave time-offset of new IDEN-Lead mode with master direction East channel, its slave greenwave time-offsets and slave direction North are unchanged, 2—the numbers #/# in parenthesis is for the new mode period-remainder/-complement of the intersection at the upper-right of the #/#, the number # in oval is for the time having run of the new mode, dotted line oval is for ww-interim-period done, solid line oval is for ww-interim-period to run or running, wherein “−” in number −# is for the rest seconds of ww-interim-period, 3—hollow arrow is for formed greenwave direction, here is the most front end of new greenwave, 4—dotted line hollow arrow is for derived greenwave direction, acrossing solid line ovals which have not run out for their ww-interim-period, 5—dotted line hollow arrow is also for pre greenwave direction, acrossing dotted line ovals which have run out for their ww-interim-period but the most front end of new mode greenwave has not arrived:

Intersection(0,0) of East 1 channel, its ww-interim-period of IDEN-Lead mode=period-remainder(0+44), at the 495^{th} second, has finished 360 seconds and 135 seconds during which 46 seconds are of the present greenwave, 44 seconds are of its ww-interim-period as labeled vertical dotted oval, and 135-46-44=45 seconds after becoming the origin intersection of the new mode East greenwave as labeled East direction arrow, i.e., the current signal time of the new mode=time-incremantal 135−the rest time 46 of the present greenwave−ww-interim-period (44+0)=45 secs; intersection(1,0), its ww-interim-period=67+10=77, at the 495^{th} second, has finished 360 seconds and 135 seconds during which 23 seconds are the rest time of the second half period of the present greenwave, 77 seconds are of its ww-interim-period as labeled vertical dotted oval, and 35 seconds of the new mode East master greenwave as labeled East direction arrow; intersection(5,0), its ww-interim-period=period-remainder (63+48)=21, at the 495^{th} second, has finished 360 seconds and 135 seconds during which 27 seconds are the rest time of the present greenwave, 21 seconds of its ww-interim-period as labeled vertical dotted oval, and 87 seconds of the new IDEN-Lead mode as labeled North direction arrow;

Intersection(1,4) of East 4 channel, its ww-interim-period of IDEN-Lead mode=25+52=77, at the 495^{th} second, has finished 360 seconds and then 135 seconds during which 20 seconds are of the rest time of the second half period of the present greenwave, 70 seconds of its ww-interim-period 77 seconds having 7 seconds to finish as labeled vertical solid oval and −7/77; intersection(4,4), its ww-interim-period of IDEN-Lead mode=3+82=85, at the 495^{th} second, has finished 360 seconds and then 135 seconds during which 42 seconds are of the rest time of the second half period of the present greenwave, 48 seconds of its ww-interim-period 85 seconds having 37 seconds to finish, i.e., 135−87−85=−37, as labeled vertical dotted oval and −37/85;

### DETAILED DESCRIPTION OF THE INVENTION

### Description Of The Preferred Embodiments, Industry Applications

A detailed description of three real time moding embodiments of the invention in conjunction with the accompanying drawings:

The created roadnet system as shown in FIG. 2, intersection as label 3, traffic as label 5, are equipped with straight/left two phases signals as label 4, with a traffic signal machine as label 6 or with sensors, controlled through the communication network as label 7 from the control center as label 8, which can obtain the configuration and control effectiveness as shown in FIG. 3—wave-initial, FIG. 4—wave-delete, FIG. 5—wave-wave by producing, executing the real time moding control methods whose flowchart is as shown in FIG. 6;

In FIG. 2, the features of a roadnet included: the coordinates(0,0) as label 1 of the origin intersection at the lower left corner of roadnet {(0,0), (6,4)} or roadnet {7,5} as label 2, which has a total of 35 intersections, 7 North-South col.-D-channels and 5 East-West row-D-channels, the set of the traffic-time of the col-D-channels Col. {7,4} {==}, for 28 corresponding North-South road-segments, the set of the traffic-time of the row-D-channels Row{5,6} {==}, for 30 corresponding East-West road-segments of the row-D-channels, the “#−#/#” as label 10 for length #−its JVQ-start-time #/its set-drive-time # of each road-segment, unit:meter−second/second, where the JVQ-start-time=JVQ-start-coefficient*jam-coefficient*road-segment-length*apart-coefficient, wherein jam-coefficient is less than or equal to 1, “equal to 1” means heavy jam, apart-coefficient is bigger than or equal to 1, “equal to 1” means keeping-the-present-status, JVQ-start-coefficient based on experimental estimate ranges 0.14˜0.22, taking their median 0.18, letting jam-coefficient=1, heavy jam, vehicle-queue-length=road-segment-length under heavy-jam, and apart-coefficient=1, keeping-the-present-status, ignoring the length of an intersection, therefore, JVQ-start-time=road-segment-length*0.18, wherein set-drive-time is calculated based on set-drive-speed=45 kilometers/hour, for an example, the length between intersection(5,0) and intersection(6,0) is 150 meters, its JVQ-start-time 27 secs/its set-drive-time 12 secs, the length between intersection(5,2) and intersection(5,3) is 125 meters, its JVQ-start-time 23 secs/its set-drive-time 10 secs, thus, the set of the traffic-times of the road-segments of East D-channels from East 1{==} to East 5{==} are {23/10,18/8,27/12,23/10,18/8,27/12}, the set of the traffic-times of the road-segments of South D-channels from South 1 {==} to South 7{==} are {27/12,18/8,23/10,27/12};

as FIG. 2, the master/slave directions' greenwave time-offsets of the present-running DIFF-mix mode greenwave at its 360^{th} second and new IDEN-Lead mode at its 0 second, intersection (6,0) as shown in label 9 as the origin of the DIFF-mix mode, master greenwave direction is West, Jam-Relief mode, relieved traffic direction is East, denoted by arrow with z# labeled 11, slave greenwave direction is North denoted by arrow with f# labeled 12, led traffic direction is also North, the set of the source-intersections of master greenwave is co1.6{(6,0), (6,1), (6,2), (6,3), (6,4)}, the set of the sums of the JVQ-start-times of the road-segments of master Jam-Relief channels includes the values of East 1{*} to East 5{*}, they all are {136,113,95,68,45,27,0}, wherein the 0 at the most right is inserted as the JVQ-start-time of their source-intersections, the other 6 values are from corresponding values of row-D-channel (5,6){==}, the set of the sum of the set-drive-times of the road-segments of the slave Lead greenwave time-offset channel: South 6{*}={0, 12, 20, 30, 42}, wherein the 0 at the most left is inserted as the set-drive-time of its source-intersection, the other 4 values are from corresponding values of col-D-channel(7,*){==} of col-D-channel (7,4){==};

The origin of new IDEN-Lead mode is the source-intersection(0,0) of slave direction greenwave as label 1, master greenwave direction East, also led traffic direction East, slave greenwave direction North, also led traffic direction North, the set of the source-intersections of master greenwave is col. 0{(0,0), (0,1), (0,2), (0,3), (0,4)}, the set of the sums of master direction channel greenwave time-offsets includes: East 1{*} to East 5{*}, their values all are {0,10,18,30,40,48,60}, wherein the 0 at the most left is inserted as the set-drive-times of their source-intersections, the other 6 values are from corresponding values of row-D-channel (5,6){==}, the set of the sum of the set-drive-times of the road-segments of the slave Lead greenwave time-offset channels: North 0{*}={0, 12, 20, 30, 42}, wherein the 0 at the most left is inserted as the set-drive-time of its source-intersection, the other 4 values are from corresponding values of col-D-channel(7,*){==} of col-D-channel (7,4){==};

In FIG. 2, a 2D greenwave real time moding control method comprises the steps of feature:

S1 setup default RATIO signal mode: (1) set North=signal main direction for all intersections in a roadnet, period=90 seconds, the time ratio for directions=1, each direction 45 seconds, straight/left 2-phase ratio=2, straight phase 30 seconds, left phase 15 seconds; (2) and get a rectangle from the roadnet, including 7×5 intersections with 7 col.-D-channels and 5 row-D-channels, and the traffic-time of every road-segments of these D-channels: JVQ-start-time/set-drive-time, where the JVQ-start-time=JVQ-start-coefficient*jam-coefficient*road-segment-length*apart-coefficient, wherein jam-coefficient is less than or equal to 1, “equal to 1” means heavy jam, apart-coefficient is bigger than or equal to 1, “equal to 1” means keeping-the-present-status, JVQ-start-coefficient based on experimental estimate ranges 0.14˜0.22, taking their median 0.18, letting jam-coefficient=1, heavy jam, vehicle-queue-length=road-segment-length under heavy-jam, and apart-coefficient=1, keeping-the-present-status, ignoring the length of an intersection, therefore, JVQ-start-time=road-segment-length*0.18, wherein set-drive-time is calculated based on set-drive-speed=45 kilometers/hour, for an example, the length between intersection(5,0) and intersection(6,0) is 150 meters, its JVQ-start-time 27 secs/its set-drive-time 12 secs, the length between intersection(5,2) and intersection(5,3) is 125 meters, its JVQ-start-time 23 secs/its set-drive-time 10 secs, thus, the set of the traffic-times of the road-segments of East D-channels from East 1{==} to East 5{==} are {23/10,18/8,27/12,23/10,18/8,27/12}, the set of the traffic-times of the road-segments of South D-channels from South 1{} to South 7{==} are {27/12,18/8,23/10,27/12},

Concrete embodiment 1, as FIG. 3, a wave-initial interim period of DIFF-mix mode in the roadnet has run for 60 seconds, its real time moding operations are as follows:

S2: calculate and configure the interim-period of new mode according to a mode-instruction: 1) the current mode of the roadnet is default RATIO mode, new mode from a mode-instruction is a Diff-mix mode, need a wave-initial interim-period, 2) configure the wi-interim-period of Jam-Relief and Lead mixed mode: (S21.1) Because of wave-initial, the current mode is RATIO mode, its origin may be any intersection, the instructed mode is Jam-Relief and Lead mixed mode, its origin is intersection(6,0), master/slave directions: master East jammed direction/slave North led direction, correspondingly, master West greenwave/slave North greenwave, the common intersection of the last intersection in the jammed direction and the first intersection in the led direction, the origin of the DiFF-mix mode, the set of the source-intersections of master greenwave channels: {(6,0), (6,1), (6,2), (6,3), (6,4)}; (S21.2) calculate and setup the time-offsets and their period-remainders of every intersection: (1) calculate and setup the master greenwave time-offsets: the sum of the traffic-times of the road-segments between the source-intersection of a master greenwave D-channel and one of its downstream intersections along their master greenwave direction, taking JVQ-start-time as the traffic-time because the instructed mode of master channel is Jam-Relief, (2) calculate slave greenwave time-offset of the slave direction greenwave time-offset D-channel, the sum of the traffic-times of the road-segments between the source-intersection, the corner intersection, the origin (6,0) of the slave direction greenwave time-offset channel of this mixed mode and one of its downstream intersections along its slave greenwave direction, according to DIFF-mix mode and the instructed mode Jam-Relief for the master channels, taking Lead mode as the mode of the slave channels and set-drive-times as the traffic-time, (3) add the two time-offsets of every intersection: Jam-Relief greenwave time-offset of every intersection of every master direction greenwave channel plus their respective Lead greenwave time-offset of the slave direction greenwave time-offset channel, the calculation results are:

The set of the Jam-Relief greenwave time-offset of every intersection of every master direction greenwave channel: East 1{*} to East 5{*}={136,113,95,68,45,27,0},
The Lead greenwave time-offsets of the slave direction greenwave time-offset channel, North 6{*}={0,12,20,30,42},
The DIFF-mixed mode greenwave time-offsets:

### East 5{*}={136+42,113+42,95+42,68+42,45+42,27+42,0+42};

### East 4{*}={136+30,113+30,95+30,68+30,45+30,27+30,0+30},

### East 3{*}={136+20,113+20,95+20,68+20,45+20,27+20,0+20},

### East 2{*}={136+12,113+12,95+12,68+12,45+12,27+12,0+12},

### East 1{*}={136+0,113+0,95+0,68+0,45+0,27+0,0+0},

Concrete to an intersection, for an example,
the 3^{rd} intersection in the 4^{th} row-D-channel, the DIFF-mixed mode greenwave time-offset of intersection(2,3)=[95]+[30]=125,
the 1^{st} intersection in the 5^{th} row-D-channel, the DIFF-mixed mode greenwave time-offset of intersection(0,4)=[136]+[42]=178,
the period-remainders of every intersection as the intersection time-offset/period 90 sec:

### East 5{*}={88,65,47,20,87,69,42};

### East 4{*}={76,53,35,8,75,57,30},

### East 3{*}={66,43,25,88,65,47,20},

### East 2{*}={58,35,17,80,57,39,12},

### East 1{*}={46,23,5,68,45,27,0},

(S21.3) configure wi-interim-period: the period-remainder 5 of intersection (2,0) and the period-remainder 8 of intersection(3,3) are all too small so made as expanding red light time, each of the others are separately divided around mid to form an wave-initial interim-period: East-West permit time+South-North permit time, denoted by #+#, the wi-interim-periods of every intersection:

### East 5{*}={44+44,33+32,23+23,10+10,44+43,35+34,21+21};

### East 4{*}={38+38,27+26,18+17,8,38+37,29+28,15+15},

### East 3{*}={33+33,22+21,13+12,44+44,33+32,24+23,10+110},

### East 2{*}={29+29,18+17,9+8,40+40,29+28,20+19,6+6},

### East 1{*}={23+23,12+11,5,34+34,23+22,24+23,0},

S3: after running out the wi-interim-period, run RATIO: if the wi-interim-period>0, display Red signal or no signal, and minus 1, wait for next second, until the wi-interim-period=0, begin to run RATIO mode.

Concrete embodiment 2, as FIG. 4, a wave-delete interim period of DIFF-mix mode in the roadnet has been started for 60 seconds after the mode had run for 360 seconds, its real time moding operations are as follows:

S2: calculate and configure the interim-period for new mode according to a mode-instruction: 1) the current mode of the roadnet is a DIFF-mix mode, new mode from a mode-instruction is a recover for RATIO mode, need a wave-delete interim-period, 2) calculate and configure the period-complement of every intersection and its wd-interim-period of Jam-Relief and Lead mixed mode; (S22.1) determine the positions of the origin intersections of two modes: the origin intersection of the current DIFF-mix mode is intersection(6,0), the default RATIO mode is synchronized with the current origin; (S22.2) calculate and setup the time-offsets and their period-remainders of every intersection: (1) calculate the period-remainders and its complements of the current DIFF-mix mode of every intersection: period time−period remainder, the calculation results of every intersection's complements are:

### East 5{*}={2,25,43,70,3,21,48};

### East 4{*}={14,37,55,82,15,33,60},

### East 3{*}={23,47,65,2,25,43,70},

### East 2{*}={32,55,73,10,33,51,78},

### East 1{*}={44,67,85,22,45,63,0},

(S22.3) configure wd-interim-period: the period-complement 10 of intersection(3,1), the period-complement 2 of intersection(3,2), the period-complement 14 of intersection(0,3), the period-complement 15 of intersection(4,3), and the period-complement 2 of intersection(0,4) are all too small so made as expanding red light time, each of the others are separately divided around mid to form an wave-delete interim-period: East-West permit time+South-North permit time, denoted by #+#, the wd-interim-periods of every intersection:

### East 5{*}={2,13+12,22+21,35+35,3,11+10,24+24};

### East 4{*}={14,19+18,28+27,41+41,15,17+16,30+30},

### East 3{*}={12+12,24+23,33+32,2,13+12,22+21,35+35},

### East 2{*}={16+16,28+27,37+36,10,17+16,26+25,39+39},

### East 1{*}={22+22,34+33,43+42,11+11,23+22,32+31,0},

S3: after running out the wd-interim-period, run RATIO: if the wd-interim-period>0, display Red signal or no signal, and minus 1, wait for next second, until the wd-interim-period=0, begin to run RATIO mode.

Concrete embodiment 3, as FIG. 5, a wave-wave interim period from DIFF-mix mode to IDEN-Lead mode in the roadnet has run for 135 seconds after the current DIFF-mix mode had run for 360 seconds, its real time moding operations are as follows:

S2: calculate and configure the interim-period of new mode according to a mode-instruction: 1) the current mode of the roadnet is DIFF-mix mode, new mode from a mode-instruction is IDEN-Lead mode, need a wave-wave interim-period, 2) calculate and configure the ww-interim-period: (S23.1) determine the positions of the origin intersections of two modes: the origin intersection of the current DIFF-mix mode is intersection(6,0), its master greenwave direction West, its slave greenwave direction North, the instructed mode is IDEN-Lead mode, its origin should be intersection(0,0), its master greenwave direction East, slave greenwave direction North; (S23.2) calculate and setup the ww-time-offsets and their period-remainders of the two modes of every intersection: (1) calculate the period-remainders and its complements of the current DIFF-mix mode of every intersection: period time−period remainder, the calculation results of every intersection's complements are:

### East 5{*}={2,25,43,70,3,21,48};

### East 4{*}={14,37,55,82,15,33,60},

### East 3{*}={23,47,65,2,25,43,70},

### East 2{*}={32,55,73,10,33,51,78},

### East 1{*}={44,67,85,22,45,63,0},

(2) calculate and configure the greenwave time-offsets and its period-remainders of new IDEN-Lead mode of every intersection, their period-remainders as following:

### East 5{*}={42,52,60,72,82,0,12};

### East 4{*}={30,40,48,60,70,78,0},

### East 3{*}={20,30,38,50,60,68,80},

### East 2{*}={12,22,30,42,52,60,72},

### East 1{*}={0,10,18,30,40,48,60},

(3) calculate the wave-wave time-offsets: the sum of the instructed mode IDEN-Lead period-remainder and the current DIFF-mix mode period-complement of every intersection, get ww-time-offset, then divided by period, and get ww-period-remainder, as following:

### East 5{*}={44,77,13,52,85,21,60};

### East 4{*}={44,77,13,52,85,21,60},

### East 3{*}={44,77,13,52,85,21,60},

### East 2{*}={44,77,13,52,85,21,60},

### East 1{*}={44,77,13,52,85,21,60},

(S23.3) configure ww-interim-period: the period-remainder 13 of col. (2,*){==} are all too small so made as expanding red light time, each of the others are separately divided around its mid to form a wave-wave interim-period: East-West permit time+South-North permit time, denoted by #+#, the ww-interim-periods of every intersection:

### East 5{*}={22+22,34+33,13,26+26,43+42,11+10,30+30};

### East 4{*}={22+22,34+33,13,26+26,43+42,11+10,30+30},

### East 3{*}={22+22,34+33,13,26+26,43+42,11+10,30+30},

### East 2{*}={22+22,34+33,13,26+26,43+42,11+10,30+30},

### East 1{*}={22+22,34+33,13,26+26,43+42,11+10,30+30},

S3: after running out the ww-interim-period, run RATIO: if the ww-interim-period>0, display Red signal or no signal, and minus 1, wait for next second, until the ww-interim-period=0, begin to run RATIO mode.

What is claimed as new and desired to be protected by Letters Patent is set forth in the following:

1. A method for real time changing mode used in road traffic signal network includes steps:
S1: Set RATIO as initial state with obtaining the length and its traffic-time of every road-segment of a roadnet;
S2 set new mode and its interim time-offsets based on a new mode instruction: 1) determine the interim category according to a mode-instruction and the current running mode: wave-initial, wave-delete, or wave-wave, said wave-initial is a mode instruction that orders an intersection to change from a RATIO mode to a greenwave mode, said wave-delete is a mode instruction that orders an intersection to change from current greenwave mode back to RATIO mode, said wave-wave is a mode instruction that orders an intersection to change from current greenwave mode to another greenwave mode; 2) calculate interim-period according to the category: (2.1) find the source-intersections and their positons of the two modes; (2.2) calculate the time-offsets and their period remainder of the new mode of every intersection: said period remainder=remainder of the time-offset/period; (2.3) configure the interim-period corresponding to the period remainder: interim-period=period remainder=master direction interim+slave direction interim;
S3 run the new mode after running out the interim-period of every intersection with red-light-on or without signals;

2. A method as defined in claim 1, wherein step S1 includes the steps of:
S11 Said traffic-time includes set-drive-time or JVQ-start-time: set-drive-time equals to time that a vehicle drives at set-drive-speed through a whole road-segment, JVQ-start-time equals to JVQ-start-coefficient*jam-coefficient*road-segment-length, where the jam-coefficient is less than or equal to one, “equals to one” means that heavy jam occurs.

3. A method as defined in claim 1, wherein step S1 includes the steps of:
S12 Said jammed vehicle-queue-length minus the length of the queue's upstream intersection without any vehicle multiplied by a value less than or equal to one.

4. A method as defined in claim 1, wherein step S1 includes the steps of:
S13 Said jammed vehicle queue-length plus the length of the traffic upstream intersection fully occupied with vehicles.

5. A method as defined in claim 1, wherein step S1 includes the steps of:
S14 Said set-drive-time minus the brake-time of set-drive-speed.

6. A method as defined in claim 1, wherein the 2) of step S2 includes the steps of:
S21 when an interim category is wave-initial, configure wi-interim-period: calculate and configure the greenwave time-offset of every intersection and its interim-period: (S21.1) according to the running rules of the two modes determine the positions of their source-intersections, for a raw RATIO, the source-intersection can be any intersection in a roadnet due to the synchronization of all the intersections, for a greenwave mode, the source-intersection can be determined by the greenwave mode, the source-intersection of a Lead greenwave mode is the first intersection in its channel led traffic direction, the source-intersection of a Jam-Relief greenwave mode is the last intersection in its relieved channel traffic direction, a Lead greenwave direction is same as its channel led traffic direction, but a Jam-Relief greenwave direction is reverse of its channel relieved traffic direction; the 2D modes includes IDEN-Lead, IDEN-Jam-Relief, DIFF-Mix, their origin source-intersections all are at a corner in an area, called as corner-intersection, for a IDEN-Lead mode, the origin intersection is the first intersection both of a direction Lead greenwave and of its cross direction Lead greenwave, for a IDEN-Jam-Relief mode, the origin intersection is the last intersection both of a direction Jam-Relief greenwave and of its cross direction Jam-Relief greenwave, for a DIFF-Mix mode, the origin intersection is the first intersection of a direction led traffic channel with Lead greenwave but the last intersection of its cross direction relieved traffic channel with Jam-Relief greenwave, set one of the two directions as master direction and the other as slave, the source-intersection of the greenwave time-offsets of slave direction channel is the corner-intersection which is one of the source-intersections of master direction greenwave channels; (S21.2) according to the running rules of the two modes determine their time-offsets of every intersection: the sum of the traffic-time from the corner-intersection to one of its downstream intersections for each mode, then get their respective remainder by dividing the sum by the period; (S21.3) configure the wi-interim-period: make a signal interim-period with the remainder, i.e., wi-interim-period;

7. A method as defined in claim 1, wherein the 2) of step S2 includes the steps of:
S22 when an interim category is wave-delete, configure wd-interim-period: calculate and configure the period-complement of every intersection and its wd-interim-period: (S22.1) according to the running rules of the two modes determine the positions of their source-intersections; (S22.2) calculate the remainder and its period-complement of the greenwave time-offset of every intersection of the present mode: period−remainder; (S22.3) configure wd-interim-period: make a signal interim period with the complement for each intersection.

8. A method as defined in claim 1, wherein the 2) of step S2 includes the steps of:
S23 when an interim category is wave-wave, configure ww-interim-period: calculate and configure the switch-time-offset of every intersection and its ww-interim-period: (S23.1) according to the running rules of the two greenwave modes determine the positions of their source-intersections; (S23.2) according to the running rules of the two greenwave modes calculate the greenwave time-offsets, its remainder, and its period-complement of the two modes for every intersection: (1) calculate the remainder and its period-complement of the greenwave time-offset of every intersection of present mode, period-complement=period−remainder, (2) according to the running rules of new greenwave mode calculate the greenwave time-offset and its remainder of every intersection of new mode, (3) calculate the switch-time-offset and its remainder of every intersection: the new mode remainder plus the present mode period-complement is switch-time-offset, divided by period, and get its switch-remainder; (S23.3) configure ww-interim-period: make a signal interim period with the switch-remainder for each intersection;

9. A method as defined in claim 1, wherein the configuring interim-period of step S2 includes steps of:
S24 configure interim-period, according to a mode instruction for an intersection make its signal interim-period just before the new mode start to run or during the second half period of the present mode period, for shorter time-offset, make red or green light time longer corresponding to the shorter time-offset, for time-offset shorter than a period, make red and green light interim-period long corresponding to the time-offset.

10. A method as defined in claim 1, wherein the 2) of step S2 includes steps of:
S25 calculate the greenwave time-offset of new mode of an intersection, when the master direction of new mode is different from the one of present mode, the source-intersection of master direction increases the half of period, or increase the half period of the master direction of present mode, for an example, the ratio is 6/4, its half period of period 90 secs is 54 secs.
